(19) United States
(12) Patent Application Publication
(10) Pub. No.: US 2017/0034814 A1
(43) Pub. Date: Feb. 2, 2017

(54) ADAPTIVE USER EQUIPMENT IMPLEMENTATION IN DIVERSITY TUNE AWAY SCENARIOS

(71) Applicant: QUALCOMM Incorporated, San Diego, CA (US)

(72) Inventors: Madhusudan Kinthada Venkata, San Diego, CA (US); Manjinder Sandhu, Poway, CA (US); Siva Kumar Jujaray, San Diego, CA (US); Nikhil Mali, Parsippany, NJ (US)

(21) Appl. No.: 14/812,097

(22) Filed: Jul. 29, 2015

(51) Int. Cl. H04W 72/04; H04L 1/00; H04L 5/00

(52) U.S. Cl. CPC H04W 72/0413; H04L 5/0057; H04L 1/0009

(57) ABSTRACT

A method for managing diversity tune away (DTA) on a mobile communication device includes: determining a start of the DTA from a first radio access technology (RAT) to a second RAT before the start of the DTA; transmitting a first aperiodic channel quality indicator/rank indicator (CQI/RI) report to a network on the first RAT prior to the start of the DTA; determining an end of the DTA before the end of the DTA; and transmitting a second aperiodic CQI/RI report to the network on the first RAT prior to the end of the DTA.

### BACKGROUND

Long term evolution (LTE) radio access technology (RAT) employs diversity reception techniques using more than one receiver and antenna (i.e., multiple input multiple output (MIMO)) to increase throughput. Some multi-subscriber identity module (SIM) multi-standby (MSMS) mobile communication devices (user equipment) supporting LTE use diversity tune away (DTA) techniques. In such techniques, one of the LTE receive chains is used for tune away in order to decode pages and/or measurements on the RATs. However, a drop in throughput for LTE may occur during DTA due to the mobile communication device periodically losing the diversity receive chain.

The mobile communication device may calculate instantaneous channel quality conditions (e.g., channel quality indicators (CQIs)). CQI values may correspond to channel parameters, for example, signal-to-noise ratio (SNR), signal-to-interference and noise ratio (SINR), power of received signal, data rates, etc.

For LTE, the mobile communication device may periodically report the CQI and a rank indictor (RI) to the network. The RI may equal one (i.e., one data stream transmission on one radio frequency (RF) chain) during the DTA, and the RI may equal two (i.e., two data stream transmissions, one on each RF chain) when LTE operates in diversity mode.

When LTE loses the diversity chain in connected mode (e.g., one of two RF chains tunes away from LTE to another RAT to decode pages and/or perform channel measurements), LTE will report a lower RI during the DTA duration. The network uses the CQI and RI to change the transmission mode of the mobile communication device. Consequently, lower CQI and RI may result in lower data throughput for LTE.

When the DTA ends, LTE will get back its diversity chain and the mobile communication device will report a higher RI. However, some time may elapse between the end of the DTA and the subsequent periodic CQI and RI reporting by the mobile communication device. While the network can change the transmission mode corresponding to the CQI and RI report received from the mobile communication device, the relatively slow response of the network scheduler to the CQI and RI reported by the mobile communication device may result in an extended duration of block error rate (BLER) and/or low throughput due to the delay between the start and/or end of the DTA and the periodic CQI/RI report.

### SUMMARY

Apparatuses and methods for reducing network response time to changing mobile communication device capabilities due to DTA are provided.

According to various embodiments there is provided a method for managing diversity tune away (DTA) on a mobile communication device. In some embodiments, the method may include: determining a start of the DTA from a first radio access technology (RAT) to a second RAT before the start of the DTA; transmitting a first aperiodic channel quality indicator/rank indicator (CQI/RI) report to a network on the first RAT prior to the start of the DTA; determining an end of the DTA before the end of the DTA; and transmitting a second aperiodic CQI/RI report to the network on the first RAT prior to the end of the DTA.

According to various embodiments there is provided a mobile communication device. In some embodiments, the mobile communication device may include: a first radio frequency (RF) chain; a second RF chain; and a control unit coupled to the first RF chain and the second RF chain.

The control unit may be configured with processor-executable instructions to: determine a start of a diversity tune away (DTA) from a first radio access technology (RAT) to a second RAT before the start of the DTA; transmit a first aperiodic channel quality indicator/rank indicator (CQI/RI) report to a network on the first RAT prior to the start of the DTA; determine an end of the DTA before the end of the DTA; and transmit a second aperiodic CQI/RI report to the network on the first RAT prior to the end of the DTA.

According to various embodiments there is provided a method for managing diversity tune away (DTA) on a mobile communication device. In some embodiments, the method may include: inhibiting transmission of periodic channel quality indicator/rank indicator (CQI/RI) reports from the mobile communication device to the network on a first radio access technology (RAT) prior a start of the DTA to a second RAT; in response to receiving a first aperiodic CQI/RI report request from the network on the first RF chain at the start of the DTA, transmitting a first CQI/RI report to the network on the first RAT after the start of the DTA; inhibiting further transmission of periodic CQI/RI reports from the mobile communication device to the network prior to an end of the DTA; and in response to receiving a second aperiodic CQI/RI report request from the network on the first RF chain at the end of the DTA, transmitting a second CQI/RI report to the network on the first RAT after the end of the DTA.

According to various embodiments there is provided a method for managing diversity tune away (DTA) on a mobile communication device. In some embodiments, the method may include: reporting a first rank indicator (RI) to a network during the DTA; receiving, at the mobile communication device, modulation and coding scheme (MCS) and block error rate (BLER) information from the network; determining block error rate (BLER) based on error checking of received data packets; evaluating the MCS and BLER for a specified signal-to-noise ratio over a plurality of system frames; and based on the BLER for the specified signal-to-noise ratio, reporting a second RI during the DTA.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1A is a block diagram illustrating a mobile communication device according to various embodiments;

FIG. 1B is a diagram illustrating a network environment for various embodiments;

FIG. 2 is a flowchart illustrating a method for synchronizing network transmission mode with DTA on a mobile communication device according to various embodiments;

FIG. 3 is a flowchart illustrating a method for characterizing network scheduling during DTA by a mobile communication device according to various embodiments; and

FIG. 4 is a flowchart illustrating a method for initiating unsolicited aperiodic RI reports, according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

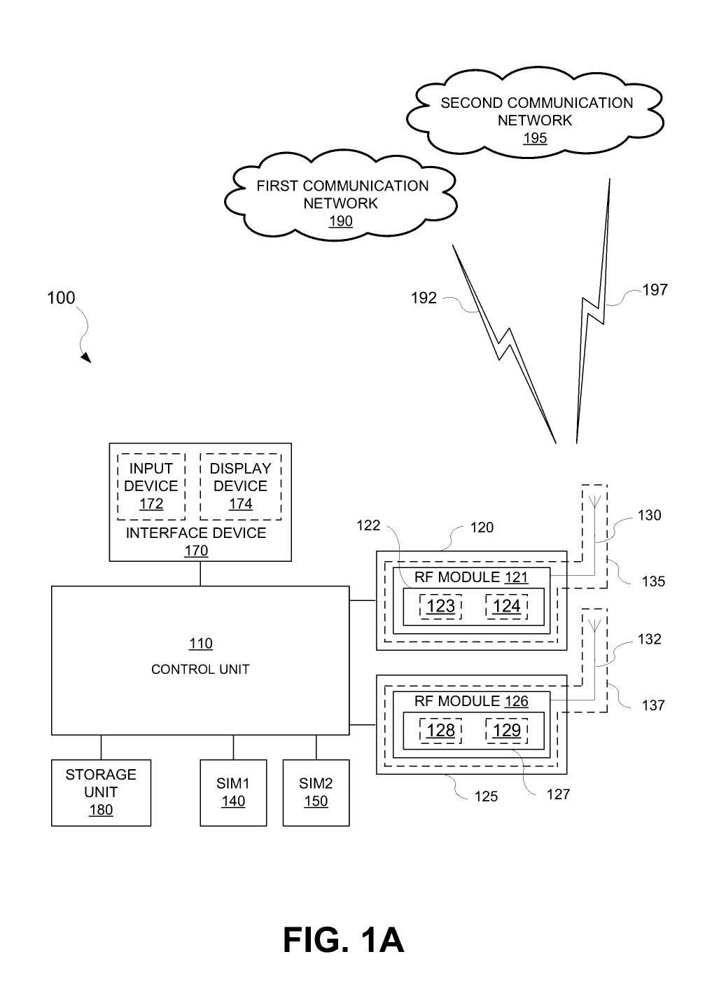

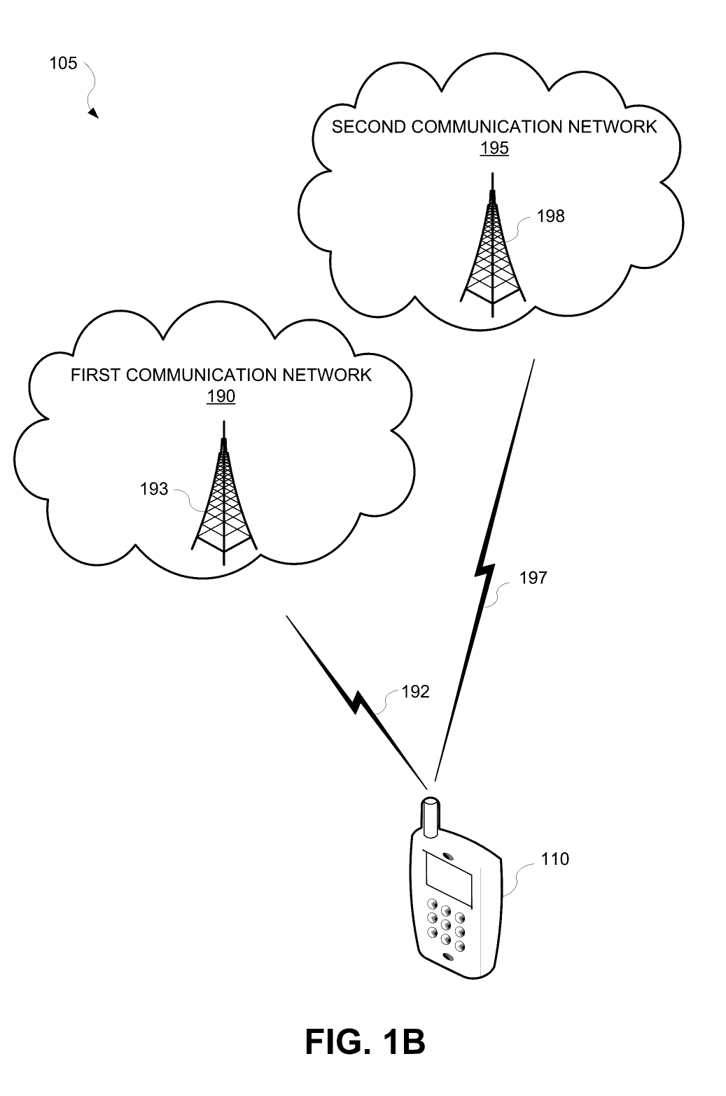

FIG. 1A is a block diagram illustrating a mobile communication device 100 according to various embodiments. As illustrated in FIG. 1A, the mobile communication device 100 may include a control unit 110, a first communication unit 120, a second communication unit 125, a first antenna 130, a second antenna 132, a first SIM 140, a second SIM 150, a user interface device 170, and a storage unit 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communication units) and may interface with one or more antennas without departing from the scope of the present inventive concept.

The first communication unit 120 may include, for example, but not limited to, a first RF module 121. The first RF module 121 may include, for example, but not limited to a first transceiver 122. The first transceiver 122 may include, for example, but not limited to a first receiver 123 and a first transmitter 124. A first RF chain 135 may include, for example, but not limited to the first antenna 130 and the first RF module 121.

The second communication unit 125 may include, for example, but not limited to, a second RF module 126. The second RF module 126 may include, for example, but not limited to a second transceiver 127. The second transceiver 127 may include, for example, but not limited to a second receiver 128 and a second transmitter 129. A second RF chain 137 may include, for example, but not limited to the second antenna 132 and the second RF module 126.

One of ordinary skill in the art will appreciate that various embodiments of the mobile communication device 100 may be provided. For example, the mobile communication device 100 may include more or less than two communication units and/or more or less than two antennas. Further, further each RF chain may include a receiver, but only one transmitter may be provided. One of ordinary skill in the art will appreciate that the above are non-limiting examples and other variations are possible without departing from the scope of the present inventive concept.

A SIM (for example the first SIM 140 and/or the second SIM 150) in various embodiments may be a universal integrated circuit card (UICC) that is configured with SIM and/or universal SIM (USIM) applications, enabling access to global system for mobile communications (GSM) and/or universal mobile telecommunications system (UMTS) networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card. A SIM card may have a CPU, ROM, RAM, EEPROM and I/O circuits. An integrated circuit card identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an international mobile subscriber identity (IMSI), a set of SIM application toolkit (SAT) commands, and other network provisioning information, as well as provide storage space for phone book database of the user's contacts. As part of the network provisioning information, a SIM may store home identifiers (e.g., a system identification number (SID)/network identification number (NID) pair, a home public land mobile network (HPLMN) code, etc.) to indicate the SIM card network operator provider.

The first SIM 140 may associate the first communication unit 120 with a first subscription (Sub1) 192 associated with a first radio access technology (RAT) on a first communication network 190 and the second SIM 150 may associate the second communication unit 125 with a second subscription (Sub2) 197 associated with a second RAT on a second communication network 195. When a RAT is active, the corresponding communication unit 120, 125 receives and transmits signals on the active RAT. When a RAT is idle, the corresponding communication unit 120, 125 receives but does not transmit signals on the idle RAT.

For convenience, the various embodiments are described in terms of DSDS mobile communication devices. However, one of ordinary skill in the art will appreciate that the present inventive concept may be extended to any type of Multi-SIM Multi-Standby (MSMS), and/or Multi-SIM Multi-Active (MSMA) mobile communication devices without departing from the scope of protection.

The first communication network 190 and the second communication network 195 may be operated by the same or different service providers, and/or may support the same or different RATs, for example, but not limited to, GSM, CDMA, WCDMA, and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the first and second communication units 120, 125, the user interface device 170, and the storage unit 180. The control unit 110 may be a programmable device, for example, but not limited to, a microprocessor (e.g., general-purpose processor, baseband modem processor, etc.) or microcontroller.

The storage unit 180 may be configured to store operating systems and/or application programs for operation of the mobile communication device 100 that are executed by the control unit 110, as well as to store application data and user data.

FIG. 1B is a diagram illustrating a network environment 105 for various embodiments. Referring to FIGS. 1A and 1B, the mobile communication device 100 may be configured to communicate with the first communication network 190 on the first subscription 192 and the second communication network 195 on the second subscription 197. One of ordinary skill in the art will appreciate that the mobile communication device may configured to communicate with more than two communication networks and may communicate on more than two subscriptions without departing from the scope of the inventive concept.

The first communication network 190 and the second communication network 195 may implement the same or different radio access technologies (RATs). For example, the first communication network 190 may be an LTE network and the first subscription 192 may be an LTE subscription. The second communication network 195 may be a GSM network. Alternatively, the second communication network 195 may implement another RAT including, for example, but not limited to, Long Term Evolution (LTE), Wideband Code Division Multiple Access (WCDMA), and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art will appreciate that the network environment 105 may include any number of communication networks, mobile communication devices, and BTSs without departing from the scope of the present inventive concept.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art will appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

Various embodiments provide methods and apparatuses for synchronizing CQI and RI reporting with the start and end of DTA.

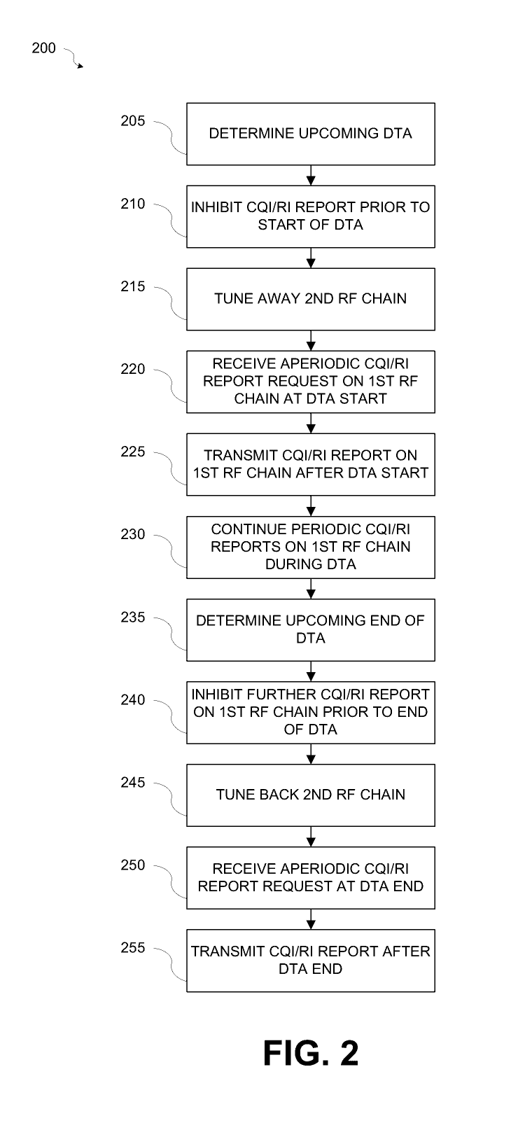

In some embodiments, the mobile communication device 100 may force the network to transmit an aperiodic CQI/RI report request. FIG. 2 is a flowchart illustrating a method 200 for synchronizing a network transmission mode with diversity tune away (DTA) on a mobile communication device, according to various embodiments. Referring to FIGS. 1A-2, the control unit 110 of the mobile communication device 100 may determine a start of an upcoming DTA to a second RAT for the second RF chain 137 before the DTA starts (205). For example, the first RF chain 135 and the second RF chain 137 may be configured for diversity reception on a first RAT (e.g., LTE or another RAT). The control unit 110 may determine that the second RF chain 137 will tune away to the second RAT (e.g., GSM or another RAT) on a second network (e.g., the second communication network 195).

For the first RAT (e.g., LTE), a system frame may include ten subframes, each subframe having a one millisecond duration. For instance, the control unit 110 may configure the mobile communication device 100 to transmit periodic CQI reports not less than every 30 milliseconds (i.e., three system frames) or some other suitable amount of time (or system frames). The control unit 110 may inhibit transmission of periodic CQI/RI report(s) to a first network (e.g., the first communication network 190) by the first RF chain 135 prior to the start of the upcoming DTA (210). For example, the control unit 110 may inhibit the periodic CQI/RI reports for at least two consecutive reporting cycles (or other suitable number of reporting cycles) prior to the start of the upcoming DTA. The control unit 110 may cause the second RF chain 137 to tune away to the second RAT on the second network (215).

In response to inhibiting the periodic CQI/RI reports, the mobile communication device 100 may receive an aperiodic CQI/RI report request on the first RF chain 135 from the first network at the start of the DTA (220). The control unit 110 may cause the first communication unit 120 to transmit an aperiodic CQI/RI report on the first RF chain 135 after the start of the DTA (225). For example, within a period of time (e.g., within four milliseconds or four subframes), the control unit 110 may cause the first communication unit 120 to report a lower CQI/RI value than the CQI/RI value reported prior to the DTA. For instance, if an RI value equal to two was reported prior to the DTA, the control unit 110 may cause the first communication unit 120 to report an RI value equal to one in response to the aperiodic CQI/RI report request. In various embodiments, the aperiodic CQI/RI report may be transmitted on the physical uplink control channel (PUCCH).

In response to receiving the CQI/RI reports from the mobile communication device 100, the first network may change a transmission mode within a period of time (e.g., within a time period corresponding to the network's adaptation rate to a reported change in RI) to correspond to the reduced capability (as indicated by the lower CQI/RI value) of the mobile communication device 100. For example, the first network may change the transmission mode within a time period corresponding to the network's adaptation rate to the reported change in RI (i.e., the time the network takes to change the transmission mode based on a reported RI). The control unit 110 may cause the first communication unit 120 to continue transmitting periodic CQI/RI reports on the first RF chain 135 during the DTA (230).

During the DTA, the control unit 110 may detect the upcoming end of the DTA (235). The control unit 110 may inhibit further transmission of the periodic CQI/RI reports to the first network before the end of the DTA (240). For example, the control unit 110 may inhibit the periodic CQI/RI reports for at least two consecutive reporting cycles prior to the end of the DTA. Inhibiting the periodic CQI/RI reports may cause the first network to transmit an aperiodic CQI/RI report request at the end of the DTA. The control unit 110 may cause the second RF chain 137 to tune back to the first RAT on the first network (245).

The mobile communication device 100 may receive the aperiodic CQI/RI report request from the first network at the end of the DTA (250). The control unit 110 may cause the first communication unit 120 to transmit a CQI/RI report to the first network on the first RF chain 135 after the end of the DTA (255). For example, within a period of time (e.g., within four milliseconds or four subframes), the control unit 110 may cause the first communication unit 120 to report a higher CQI/RI value than the CQI/RI value reported during the DTA. For instance, if an RI value equal to one was reported during the DTA, the control unit 110 may cause the first communication unit 120 to report an RI value equal to two in response to the aperiodic CQI/RI report request. Upon receipt of the CQI/RI report from the mobile communication device 100, the first network may change the transmission mode within a period of time (e.g., within a time period corresponding to the network's adaptation rate to the reported change in RI) to correspond to the reduced capability of the mobile communication device 100. For example, the first network may change the transmission mode within a time period corresponding to the network's adaptation rate to the reported change in RI.

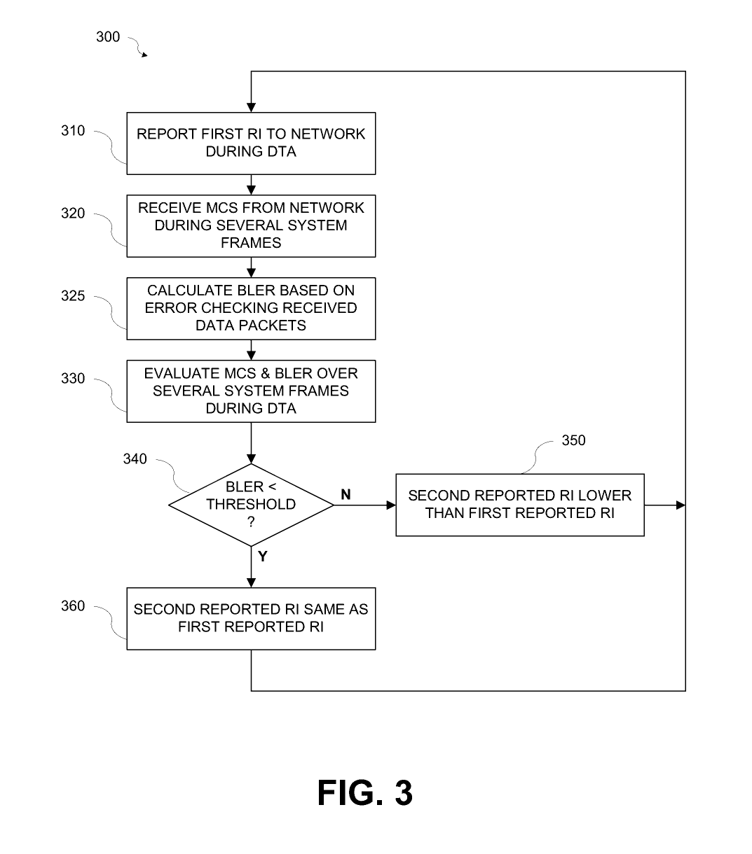

FIG. 3 is a flowchart illustrating a method 300 for characterizing network scheduling during DTA by a mobile communication device (e.g., 100 in FIGS. 1A and 1B), according to various embodiments. Referring to FIGS. 1A-3, the control unit 110 may cause the first communication unit 120 to report a first RI to the first network during the DTA (310). For example, the control unit 110 may cause the mobile communication device 100 to report an RI equal to one during the DTA. Alternatively, during the DTA, the mobile communication device 100 may report an RI equal to the RI of the mobile communication device 100 prior to the DTA (e.g., RI equal to two).

The mobile communication device 100 may receive modulation and coding scheme (MCS) information from the first network (320). The mobile communication device 100 (e.g., the control unit 110) may determine block error rate (BLER) based on error checking of received data packets (325).

The control unit 110 may evaluate the MCS and the BLER determined based on the packets received at a specified signal-to-noise ratio (SNR) over several system frames, including the DTA periods (330). For example, the mobile communication device 100 may receive transmissions from the first network for RI equal to two even though the mobile communication device 100 reported RI equal to one. The control unit 110 may determine if the BLER for the reported RI was acceptable for the specified SNR (i.e., the BLER is below a threshold) (340). The mobile communication device 100 may be configured with BLER thresholds for specified MCS and SNR. For instance, the SNR for the mobile communication device 100 close to a BTS (e.g., BTS 193 of the first communication network 190) may be higher than the SNR for the mobile communication device 100 nearer to the edge of the cell served by the BTS. Therefore, the expected BLER for the mobile communication device 100 close to the BTS may be lower than the expected BLER for the mobile communication device 100 nearer to the edge of the cell.

In response to determining that the BLER during the DTA was not acceptable (i.e., the BLER is above a threshold) (340—N), the control unit 110 may report a second RI to the network during the next DTA (350). For example, the control unit 110 may report a lower RI if the BLER is equal to or greater than a threshold for a specified MCS and SNR. In response to determining that the BLER during the DTA was acceptable (i.e., the BLER is below a threshold) (340—Y), the control unit 110 may report the same RI for the next DTA (360). For example, the control unit 110 may report the same RI if the BLER is lower than a threshold for the MCS and SNR.

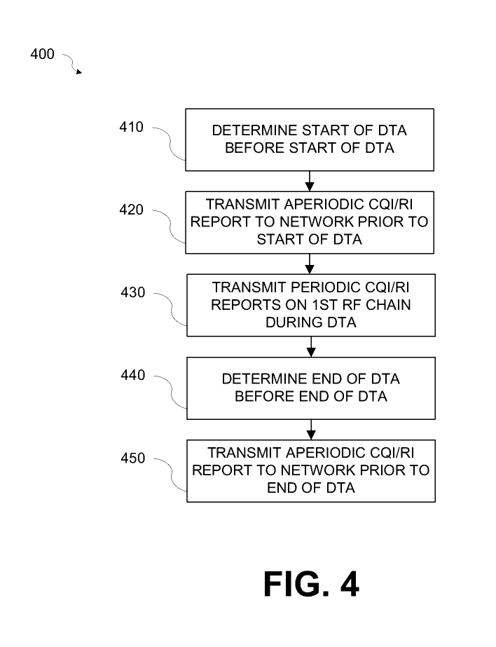

In some embodiments, the mobile communication device 100 may initiate unsolicited (i.e., not in response to an aperiodic CQI/RI report request from a network) aperiodic CQI/RI reports to a network configured to accept the unsolicited aperiodic reports. FIG. 4 is a flowchart illustrating a method 400 for initiating unsolicited aperiodic RI reports, according to various embodiments. Referring to FIGS. 1A-4, the control unit 110 of the mobile communication device 100 may determine a start of an upcoming DTA before the upcoming DTA starts (410).

The control unit 110 may cause the mobile communication device 100 to transmit an unsolicited aperiodic RI and/or CQI/RI report to a network (e.g., the first network 190) prior to the start of the DTA (420). For example, the control unit 110 may determine that the DTA will start in fifteen milliseconds and the network's adaptation rate to a reported change in RI is ten milliseconds. The control unit 110 may cause the mobile communication device 100 to transmit an aperiodic CQI/RI report with a lower RI to the network after five subframes have been transmitted (i.e., after five milliseconds). In various embodiments, the aperiodic CQI/RI report may be transmitted on the physical uplink control channel (PUCCH). As a result of receiving the aperiodic CQI/RI report from the mobile communication device 100, the network may change the transmission mode at the start of the DTA. The control unit 110 may cause the mobile communication device 100 to transmit periodic CQI/RI reports during the DTA (430).

Similarly, the control unit 110 may determine the upcoming end of the DTA before the end of the DTA (440). The control unit 110 may cause the mobile communication device 100 to send an unsolicited aperiodic RI and/or CQI/RI report with a higher RI to the network before the end of the DTA at a time based on the network's adaptation rate to a reported change in RI(450). As a result of receiving the aperiodic CQI/RI report from the mobile communication device 100, the network may change the transmission mode at the end of the DTA.

The methods 200, 300, and 400 described with respect to FIGS. 2-4, respectively, may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for managing diversity tune away (DTA) on a mobile communication device, the method comprising:
determining a start of the DTA from a first radio access technology (RAT) to a second RAT before the start of the DTA;
transmitting a first aperiodic channel quality indicator/rank indicator (CQI/RI) report to a network on the first RAT prior to the start of the DTA;
determining an end of the DTA before the end of the DTA; and
transmitting a second aperiodic CQI/RI report to the network on the first RAT prior to the end of the DTA.

2. The method of claim 1, further comprising:
transmitting periodic CQI/RI reports on the first RAT during the DTA.

3. The method of claim 1, wherein the first aperiodic CQI/RI report is transmitted to the network prior to the start of the DTA at a time equal to the network's adaptation rate to a reported change in RI.

4. The method of claim 1, wherein the second aperiodic CQI/RI report is transmitted to the network prior to the end of the DTA at a time equal to the network's adaptation rate to a reported change in RI.

5. The method of claim 1, wherein the first aperiodic CQI/RI report is initiated without receiving an aperiodic CQI/RI report request from the network.

6. The method of claim 1, wherein the second aperiodic CQI/RI report is initiated without receiving an aperiodic CQI/RI report request from the network.

7. The method of claim 1, wherein the first aperiodic CQI/RI report and the second aperiodic CQI/RI report are transmitted on one of a physical uplink control channel (PUCCH) and a physical uplink shared channel (PUSCH).

8. A mobile communication device, comprising:
a first radio frequency (RF) chain;
a second RF chain; and
a control unit coupled to the first RF chain and the second RF chain, and configured with processor-executable instructions to:
determine a start of a diversity tune away (DTA) from a first radio access technology (RAT) to a second RAT before the start of the DTA;
transmit a first aperiodic channel quality indicator/rank indicator (CQI/RI) report to a network on the first RAT prior to the start of the DTA;
determine an end of the DTA before the end of the DTA; and
transmit a second aperiodic CQI/RI report to the network on the first RAT prior to the end of the DTA.

9. The mobile communication device of claim 8, wherein the control unit is further configured with processor-executable instructions to transmit periodic CQI/RI reports on the first RAT during the DTA.

10. The mobile communication device of claim 8, wherein the control unit is further configured with processor-executable instructions to transmit the first aperiodic CQI/RI report to the network prior to the start of the DTA at a time equal to the network's adaptation rate to a reported change in RI.

11. The mobile communication device of claim 8, wherein the control unit is further configured with processor-executable instructions to transmit the second aperiodic CQI/RI report to the network prior to the end of the DTA at a time equal to the network's adaptation rate to a reported change in RI.

12. The mobile communication device of claim 8, wherein the control unit is further configured with processor-executable instructions to initiate the first aperiodic CQI/RI report without receiving an aperiodic CQI/RI report request from the network.

13. The mobile communication device of claim 8, wherein the control unit is further configured with processor-executable instructions to initiate the second aperiodic CQI/RI report without receiving an aperiodic CQI/RI report request from the network.

14. The mobile communication device of claim 8, wherein the control unit is further configured with processor-executable instructions to trnamit the first aperiodic CQI/RI report and the second aperiodic CQI/RI report on one of a physical uplink control channel (PUCCH) and a physical uplink shared channel (PUSCH).

15. A method for managing diversity tune away (DTA) on a mobile communication device, the method comprising:
inhibiting transmission of periodic channel quality indicator/rank indicator (CQI/RI) reports from the mobile communication device to a network on a first radio access technology (RAT) prior to a start of the DTA to a second RAT;
in response to receiving a first aperiodic CQI/RI report request from the network at the start of the DTA, transmitting a first CQI/RI report to the network on the first RAT after the start of the DTA;
inhibiting transmission of further periodic CQI/RI reports on the first RAT from the mobile communication device to the network prior to an end of the DTA; and
in response to receiving a second aperiodic CQI/RI report request from the network at the end of the DTA, transmitting a second CQI/RI report to the network on the first RAT after the end of the DTA.

16. The method according to claim 15, wherein the first CQI/RI report indicates lower CQI/RI values than CQI/RI values reported prior to the start of the DTA.

17. The method according to claim 15, wherein the second CQI/RI report indicates higher CQI/RI values than CQI/RI values reported during the DTA.

18. The method according to claim 15, wherein the inhibiting transmission of periodic CQI/RI reports from the mobile communication device to the network prior to the start of the DTA comprises:
inhibiting transmission of periodic CQI/RI reports for at least two consecutive reporting periods prior to the start of the DTA.

19. The method according to claim 15, wherein the inhibiting transmission of further periodic CQI/RI reports from the mobile communication device to the network prior to the end of the DTA comprises:
inhibiting transmission of periodic CQI/RI reports for at least two consecutive reporting periods prior to the end of the DTA.

20. The method according to claim 15, wherein the first CQI/RI report is transmitted to the network within four subframes after receiving the first aperiodic CQI/RI report request.

21. The method according to claim 15, wherein the second CQI/RI report is transmitted to the network within four subframes of receiving the second aperiodic CQI/RI report request.

22. A method for managing diversity tune away (DTA) on a mobile communication device, the method comprising:
reporting a first rank indicator (RI) to a network during the DTA;
receiving, at the mobile communication device, modulation and coding scheme (MCS) information from the network;
determining block error rate (BLER) based on error checking of received data packets;
evaluating the MCS information and the BLER for a specified signal-to-noise ratio (SNR) over a plurality of system frames; and
reporting a second RI during the DTA based on a BLER threshold corresponding to the MCS and SNR.

23. The method of claim 22, wherein the reporting a first RI to the network during the DTA comprises reporting a lower RI than an RI reported prior to entering the DTA.

24. The method of claim 22, wherein the reporting a first RI to the network during the DTA comprises reporting an RI equal to an RI reported prior to entering the DTA.

25. The method of claim 22, wherein the second RI reported to the network is lower the first RI reported to the network when the BLER is equal to or greater than a threshold.

26. The method of claim 22, wherein the second RI reported to the network is the same as the first RI reported to the network when the BLER is less than a threshold.
